(19) United States
(12) Patent Application Publication
(10) Pub. No.: US 2022/0230372 A1
(43) Pub. Date: Jul. 21, 2022

(54) ALTERNATE TEXT AND AUDIO DESCRIPTION FOR GRAPHICAL CONTENT

(71) Applicant: ZEMBULA, INC., Portland, OR (US)

(72) Inventors: Carl-Einar Ingemar Thornér, Happy Valley, OR (US); Robert Jenkin Haydock, Portland, OR (US)

(73) Assignee: ZEMBULA, INC., Portland, OR (US)

(21) Appl. No.: 17/648,275

(22) Filed: Jan. 18, 2022

Related U.S. Application Data
(60) Provisional application No. 63/139,550, filed on Jan. 20, 2021.

(51) Int. Cl. G06T 11/60; G10L 13/02; G06F 40/186

(52) U.S. Cl. CPC G06T 11/60; G06F 40/186; G10L 13/02

(57) ABSTRACT

According to an example, a server-based platform processes requests for graphical content on behalf of client computing devices. The server-based platform can generate and provide alternate text for the graphical content and/or audio representations of the alternate text to the client computing device.

### CROSS REFERENCE TO RELATED APPLICATIONS

This application claims priority to U.S. Patent Application Ser. No. 63/139,550, filed Jan. 20, 2021, the entirety of which is hereby incorporated herein by reference for all purposes.

### BACKGROUND

Computer executable application programs can present graphical data to users via a graphical user interface. Such graphical data can include images, videos, and other motion graphics that contain text information and other graphical components. Local processing of graphical data, including retrieving and rendering of graphical components can consume significant processing resources of the computing platform that executes the application program. Furthermore, application programs that are capable of locally implementing logic for the retrieval and rendering of graphical components can significantly increase the size and complexity of the application program.

### SUMMARY

A computing system is disclosed that is capable of generating alternate text and/or an audio description for graphical content that is dynamically generated or otherwise selected based on contextual information for a requesting client. According to an example, the computing system receives a first request for a content item from a client computing device via a communications network. The computing system extracts contextual information from the first request, and obtains a graphical content item for the client computing device based, at least in part, on the contextual information by generating the graphical content item or selecting the graphical content item from a plurality of available graphical content items. The computing system generates alternate text and/or an audio description for the graphical content item. The computing system establishes a network resource identifier from which the alternate text and/or audio description is retrievable by the client computing device. responsive to the first request, the computing system sends a first response including the content item to the client computing device via the communications network in which the content item includes or identifies the graphical content item and the network resource identifier. The computing system receives from the client computing device via the communications network a second request for the alternate text and/or audio description indicated by the network resource identifier. Responsive to the second request, the computing system sends a second response including the alternate text and/or audio description to the client computing device via the communications network.

### BRIEF DESCRIPTION OF THE DRAWINGS

FIG. 1 shows an example computing system.

FIG. 2 shows a flow diagram of an example method that can be performed by aspects of the computing system of FIG. 1.

FIG. 3A schematically depicts an example template and associated rule that can be implemented by the server system of FIG. 1.

FIG. 3B schematically depicts a plurality of parameter groups that can be used as input to generate or select graphical content for a client computing device.

FIGS. 4A, 4B, 5A, 5B, 6A, and 6B depict examples of graphical content that can be generated by the server system of FIG. 1 for a client computing device.

FIG. 7 depicts a flow diagram of another example method that can be performed by aspects of the computing system of FIG. 1.

FIG. 8A depicts an example syntax for computer executable instructions contained within the content item described with reference to the method of FIG. 7.

FIG. 8B depicts an example of computer executable instructions contained within the content item described with reference to method 700 of FIG. 7, using the syntax of FIG. 8A.

FIG. 9 depicts an example of the client computing device of FIG. 1 presenting alternate text and/or an audio description.

FIG. 10 depicts additional aspects of the application program of FIG. 1.

FIG. 11 depicts additional aspects of the one or more server programs of FIG. 1.

### DETAILED DESCRIPTION

Graphical content items including images, videos, and other motion graphics can be dynamically generated or otherwise selected from a library of available graphical content items responsive to a request from a client computing device. As examples, the graphical content item can be generated or selected at a time that a web page is loaded or at a time that an email or other communication is opened at an application program of the client computing device. These graphical content items can be individualized for a particular context based on contextual information contained in the request, real-time application programming interface (API) calls between the client and the server, and/or contextual information referenced from data sources other than the client based on one or more identifiers contained in the request. As an example, API calls can be used to obtain contextual information from the client computing device and/or other sources, including an identity of a user of the client computing device, a device type, an application type, a communication protocol, a location of the client computing device, a time and date, a location of a package in-transit that was ordered by or for the user, and other suitable contextual information.

An alternative text tag or “alt tag” is a property that can be associated with a graphical content item to describe aspects of the graphical content item, such as visual objects and text that are present within the graphical content item. As an example, this alt tag can be used by screen reader functions or applications at the client computing device to assist visually impaired users understand the contents of graphical content within a web page or application by audibly outputting a description of the graphical content.

The above examples present potential technological problems for visually impaired individuals or other users relying on screen readers to understand the contents of graphical content, particularly where the graphical content is dynamically generated or selected in real-time or near real-time for the user based on contextual information.

The present disclosure provides several approaches that have the potential to address these and other issues. According to an example, a computing system disclosed herein receives a first request for a content item from a client computing device via a communications network. The computing system extracts contextual information from the first request, and obtains a graphical content item for the client computing device based, at least in part, on the contextual information by generating the graphical content item or selecting the graphical content item from a plurality of available graphical content items. The computing system generates alternate text and/or an audio description for the graphical content item. The computing system establishes a network resource identifier from which the alternate text and/or audio description is retrievable by the client computing device. responsive to the first request, the computing system sends a first response including the content item to the client computing device via the communications network in which the content item includes or identifies the graphical content item and the network resource identifier. The computing system receives from the client computing device via the communications network a second request for the alternate text and/or audio description indicated by the network resource identifier. Responsive to the second request, the computing system sends a second response including the alternate text and/or audio description to the client computing device via the communications network.

Within the above example, the network resource identifier (e.g., a URL) can be used by the client computing device to obtain alternate content from a remote network resource for a graphical content item. The alternate content can include alternate text information, an alternate graphical user interface (GUI) that is specifically formatted to omit the graphical content item, and/or an audio description of the graphical content as an audio file or audio stream. The alternate text information or audio description that can be audibly presented at the client computing device. For example, the alternate text can be converted to audible form by text-to-speech applied at the client computing device, or the audio description provided to the client computing device can be audibly presented to the user of the client computing device. In at least some examples, the network resource identifier can be set as the alt tag for the graphical content item. Application programs executed at the client computing device can use the network resource identifier to request and receive the alternate content that either replaces or supplements the graphical content item.

The present disclosure offers at least three approaches that can be performed by a service (e.g., of a server system) remotely located from a client computing device to obtain and provide alternate content to the client computing device over a communications network.

As a first example, a static approach can be used in which the alternate content is predefined or pre-generated for the particular graphical content item. This approach can be suitable for scenarios in which the graphical content item is pre-generated or predefined, and selected from a plurality of pre-generated or predefined graphical content items based on the contextual information associated with the request from the client computing device.

As a second example, the remotely located service can utilize text-to-speech conversion and/or computer vision to dynamically identify text or other visual objects or features that are present within the graphical content item. The identified text and/or other visual objects or features can be used to dynamically generate the alternate content that is provided to the client computing device. For example, machine synthesized speech can be generated to obtain alternate audio content that is provided to the client computing device. As another example, machine vision can be applied to the graphical content item to generate the alternate text and/or audio description.

As a third example, the alternate content can be generated using a predefined schema using the same contextual information and/or data that is used to generate the graphical content item.

These three approaches can be used together or independently of each other to provide a variety of alternate content that describes visual features that are present within the graphical content item.

In further examples, such as for graphical content that includes video having an audio component, alternate text information can be generated from voice-to-text transcription of the audio component by the service. The alternate text information can be visually displayed to the user at the client computing device alongside or overlaid upon visual content of the video. This approach can be appropriate for users that are hearing impaired, as an example.

In addition to the use of a network resource identifier within the “alt tag”, for client computing devices and their application programs that support javascript or other scripting language, the alternate content can be generated on the fly and written to the alt tag or can completely replace the coding language (e.g., HTML) of the graphical content item (e.g., an image) if the client computing device or its application is configured with images in an off/do not display setting (i.e., no presentation of images or other graphical content within a particular application, window, or frame).

In at least some examples, the processing workflow disclosed herein can function similar to a proxy server, except instead of proxying the graphical content item, the server can return information about the graphical content item based on decision rules evaluated based on data from lookup tables, API calls, and contextual information (e.g., user ID, location, device type, time). In the absence of such data the graphical content item can also be parsed using computer vision algorithms to generate alternate text and/or an audio description for the graphical content.

While the following description includes the use of the “alt tag”, it will be understood that other suitable tags (e.g., ARIA tags) can be used to hold and identify the alternate text information.

Because of the real-time nature of this approach and the flexibility of providing accessibility data for any image or video, the management and deployment of accessibility information can become easier, faster, and more efficient.

While at least some of the examples described herein generate alternate text and/or an audio description representing the alternate text for a graphical content item that is dynamically generated on the fly using particular techniques, it will be understood that the graphical content item can be dynamically generated on the fly using other suitable techniques or the graphical content item can be a predefined or static graphical content item that is not dynamically generated on the fly. Furthermore, while the use of network resource identifiers for the “alt tag” and other suitable tags is disclosed by at least some examples, it will be understood that the alternate text that is generated can be inserted directly into the “alt tag” or other suitable tag that is associated with the graphical content item prior to transmitting the computer executable instructions to the client computing device.

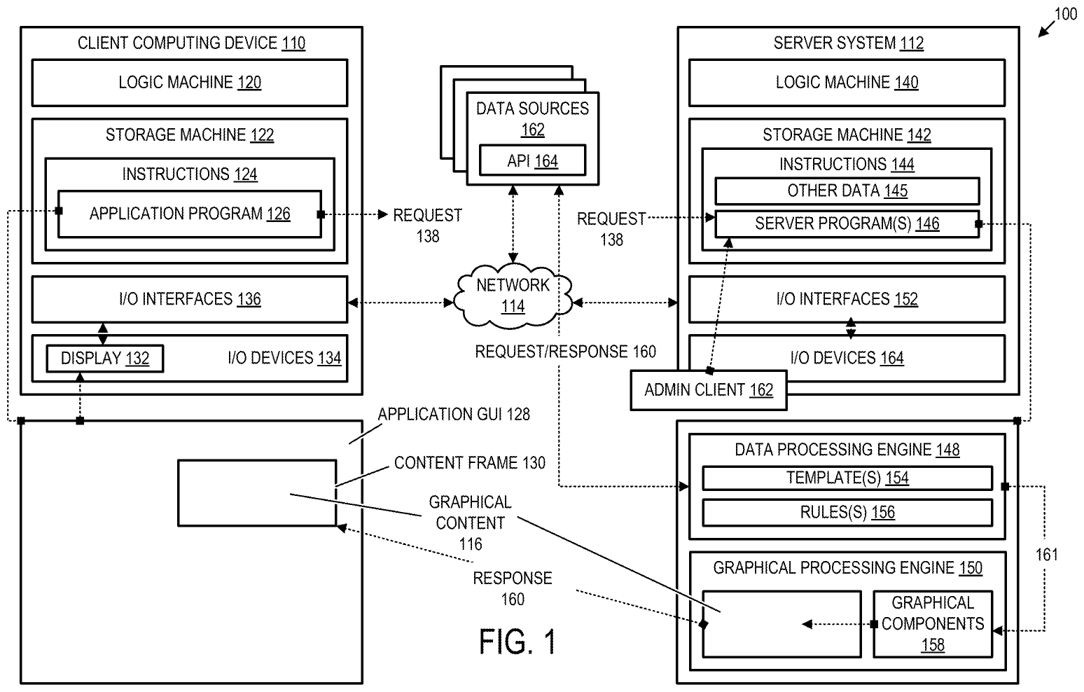

FIG. 1 shows an example computing system 100 in which a client computing device 110 interacts with a server system 112 via a communications network 114 to obtain graphical content 116 that is presented at the client computing device.

Client computing device 110 is operable by a user, and may take the form of a personal computer, mobile device, computer terminal, gaming system, entertainment system, etc. Client computing device 110 includes a logic machine 120, and a storage machine 122 having instructions 124 stored thereon that are executable by the logic machine to perform one or more of the methods and operations described herein with respect to the client computing device.

In an example, instructions 124 include an application program 126, which takes the form of a web browser application, an email application, a messaging application, or other suitable application program that features one or more application graphical user interfaces (GUIs), an example of which includes application GUI 128. Application GUI 128 includes a content frame 130 within which graphical content 116 is presented via a graphical display 132 that is included as part of input/output devices 134 of client computing device 110 or otherwise interfaces with client computing device 110 via input/output interfaces 136 (e.g., as a peripheral device). Application program 126 initiates request 138 to server system 112 for content (e.g., graphical content 116) to be returned by server system 112 to the client computing device.

Server system 112 includes one or more server computing devices remotely located from client computing device 110. Request 138 traverses network 114 and is received by server system 112. Server system 112 includes a logic machine 140 and a storage machine 142 having instructions 144 stored thereon that are executable by the logic machine to perform one or more of the methods and operations described herein with respect to the server system.

In an example, instructions 144 include data 145 and one or more server programs 146. Server programs 146 in this example include a data processing engine 148 and a graphical processing engine 150, among other suitable program components. Aspects of server program 146 are described in further detail with reference to FIG. 11.

Graphical processing engine 150, as an example, can include or take the form of a vector image processing engine configured to generate vector graphics, such as images, videos, and other graphical components. Vector graphics generated by the vector image processing engine can be converted to other forms of graphical content before being transmitted to the client computing device in at least some examples. Such conversion can be performed particularly where the application program that initiated the request at the client computing device does not support vector graphics or support for vector graphics has been disabled by the user for a given application, window, or frame. Storage machine 142 can also store local data resources, including data and/or graphical components (collectively data 145) that can be combined with data and/or graphical components obtained from remote data sources to generate graphical content 116.

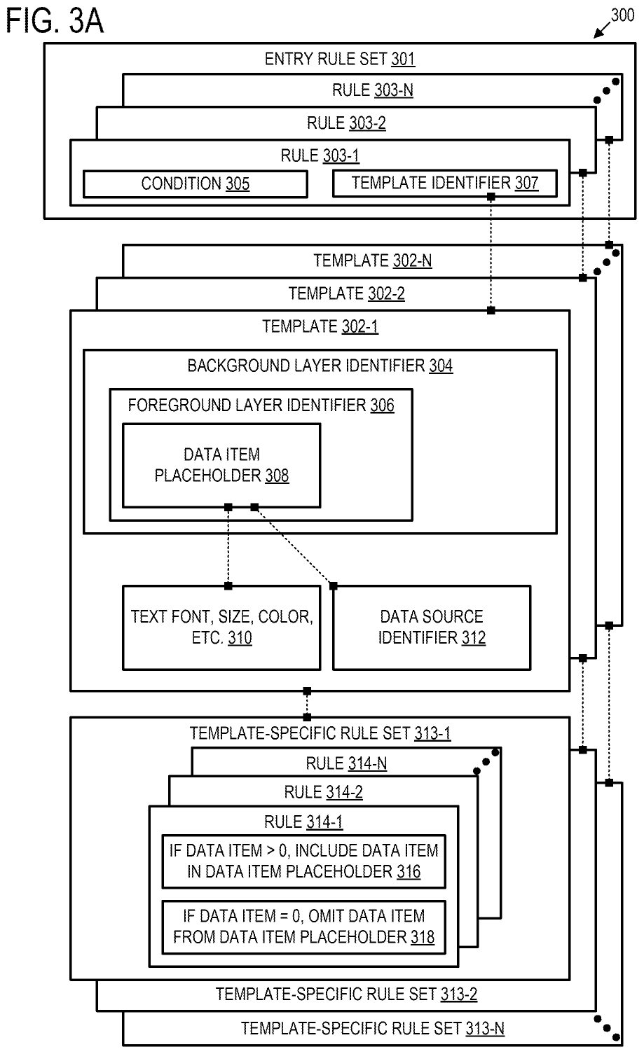

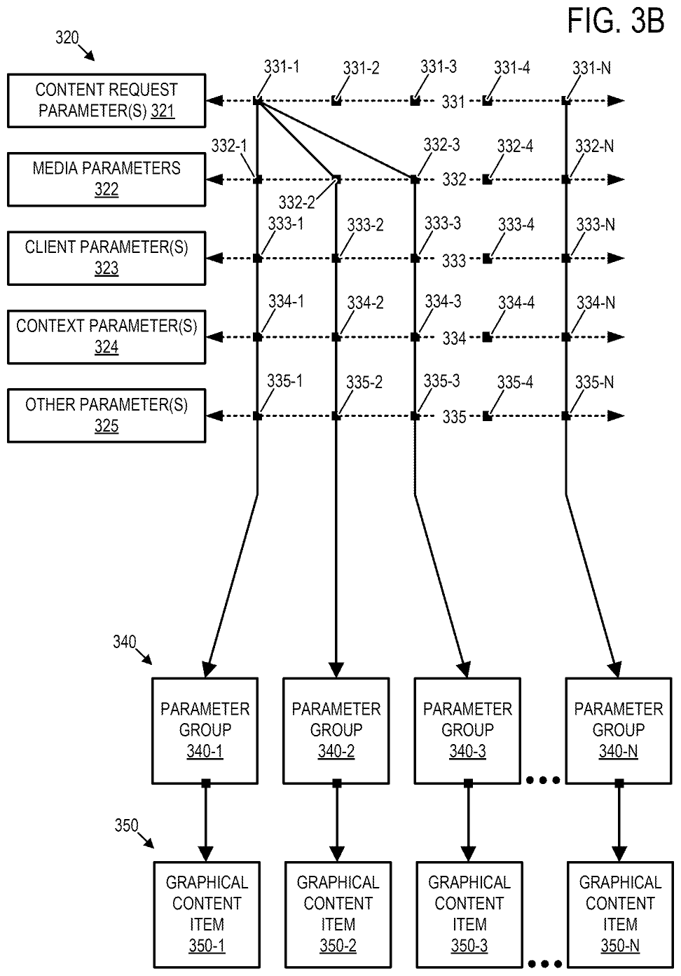

Data processing engine 148 can receive request 138 via input/output interfaces 152. Request 138 can include or otherwise indicate a variety of contextual information. Contextual information can take various forms, including a URL or other suitable network resource identifier, an identifier of application program 126, a username of a user of client computing device 110, an IP address or other network identifier of the client computing device, a geographic location identifier of the client computing device, a time that the request was initiated, a shipping tracking number or other information passed by the application program to the server system via the request, a network location identifier from which other data and/or graphical components may be retrieved by the server system on-behalf of the client computing device, among other suitable forms of contextual information. Accordingly, it will be appreciated that contextual information can include any suitable information that can be used by server system 112 to retrieve and/or or generate graphical components 158 that can be combined to obtain a graphical content item (e.g., graphical content 116). Further examples of contextual information are described with reference to FIG. 3B.

In response to request 138 including the contextual information indicated by the request, data processing engine 148 can apply or otherwise implement one or more templates 154 and/or one or more rules 156 to select, request, and receive 160 applicable data from one or more remote data sources 162 and/or local data sources (e.g., of storage machine 142) as part of generating graphical content for the client computing device. Remote data sources 162 may be hosted at one or more remote computing devices (e.g., servers). Requests indicated at 160 can take the form of application programming interface (API) requests to an API 164 of each of the one or more data sources 162 to retrieve applicable data. Data processing engine 148 processes the data and/or graphical components received from data sources 162 and/or from local storage by applying or otherwise implementing one or more of the templates 154 and/or rules 156 to obtain processed data 161. Data processing engine 148 in at least some examples provides processed data 161 to graphical processing engine 150, which in turn generates a plurality of graphical components 158 based on the processed data 161. In at least some examples, data returned by data sources 162, data retrieved from local storage, and/or processed data 161 can include one or more of graphical components 158.

Graphical processing engine 150 can utilize processed data 161 to generate, render, and combine the plurality of graphical components 158 to obtain graphical content 116 at server system 112. As an example, the graphical content generated at server system 112 can take the form of one or more vector graphics. Such vector graphics can be converted to non-vector graphic form before being transmitted to the client computing device in at least some examples. The server system 112 then sends graphical content 116 to client computing device 110 as a response 160 that traverses network 114. Client computing device 110 receives response 160 and can present the graphical content within application GUI 128 via display 132. As an example, the client computing device can insert graphical content 116 within content frame 130.

In at least some examples, templates 154 and/or rules 156 can be user defined. As an example, an administrator client 162 (e.g., a user operated client device) can interact with server programs 146 to define aspects of templates 154 and/or rules 156. A non-limiting example of a template/rule set is described in further detail with reference to FIG. 3A. Administrator client 162 can interact with server system 112 via one or more integrated input/output devices or peripheral devices 164 interfacing with input/output interfaces 152, or administrator client 162 can be remotely located as a client computing device that interacts with server system 112 via input/output interfaces 152 over network 114.

Graphical content 116 that can be generated and/or sent to the client computing device by the server system according to the disclosed techniques can take various forms, including: image formats: png, jpg, bmp, gif, webp, apng, mng, flif, heif; and streaming video formats: mp4, mov, wmv, fly, avi, avchd, WebM, MKV, as non-limiting examples. Within contexts where the client computing device supports vector graphics, graphical content 116 can include vector graphics formats.

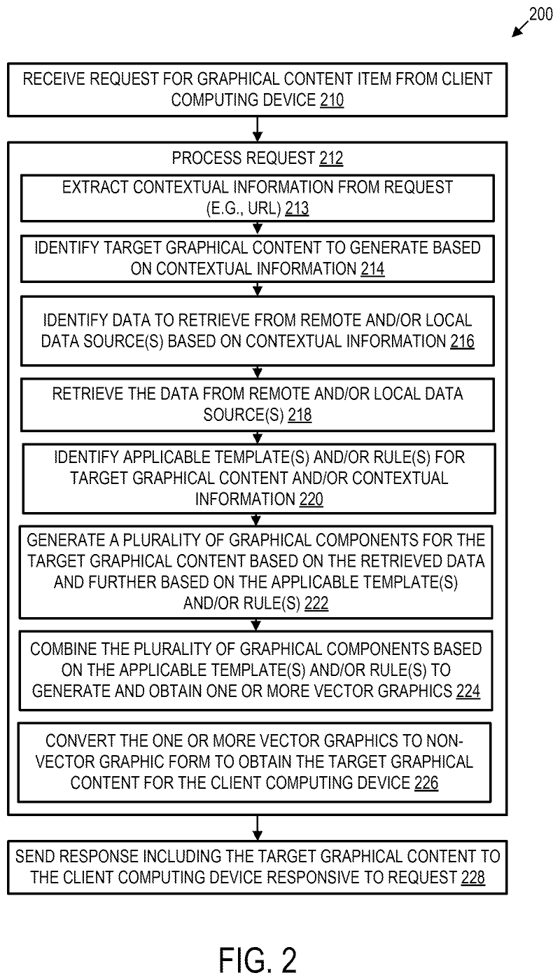

FIG. 2 shows a flow diagram of an example method 200. In an example, method 200 can be performed by server system 100 of FIG. 1 executing sever programs 146, including data processing engine 148 and graphical processing engine 150.

At 210, the method includes receiving a request (e.g., 138 of FIG. 1) for content from a client computing device, such as client computing device 110 of FIG. 1. In an example, the request can take the form of an HTTP/HTTPS request over TCP/IP. However, other suitable types of requests can be supported.

At 212, the request received at 210 is processed. As part of processing the request at 212, the method can include extracting contextual information from the request at 213. Extracting the contextual information from the request can include referencing contextual information contained in the request and/or within one or more additional API calls following the request. Additionally or alternatively, contextual information can be referenced from one or more data sources other than the client computing device based on one or more identifiers contained in the request. In an example, the contextual information indicates a URL or other network resource identifier.

At 214, the method includes identifying target graphical content to generate based on the contextual information, including at least the URL or network resource identifier indicated by the request. In at least some examples, the URL or other network resource identifier identifies the correct client and graphical content to generate and serve in response to the request. Accordingly, at 214, the method includes identifying target graphical content to generate or otherwise select on-behalf of the client computing device based on the context information extracted from the request, including the URL or other network identifier.

For the particular target graphical content identified at 214, contextual information extracted from the request and/or profile data associated with the URL/network resource identifier at the server system can be retrieved. Based on the contextual information extracted from the request and/or associated with the URL/network resource identifier, data to be retrieved from remote and/or local sources (e.g., APIs and databases) is identified at 216. For example, one or more requests can be sent to one or more different data sources 162 of FIG. 1. Such requests can include API calls, for example.

At 218, the identified data is retrieved from the remote and/or local data sources. Local data sources can refer to data stored at storage machine 142 of FIG. 1, for example. By contrast, remote data sources can again refer to one or more different data sources 162.

In at least some examples, one or more applicable templates and/or one or more rules are identified at 220 from among a plurality of templates 154 and rules 156 based on the target graphical content and/or contextual information. In the case of the target graphical content being a live image or video graphic, multiple templates or template variants can be selected based on both the retrieved data and the contextual information.

At 222, a plurality of graphical components can be generated for the target graphical content based on the retrieved data and the applicable templates and/or rules identified at 220. For example, the contextual information and retrieved data can be used to identify and/or retrieve text fonts, external images, and to calculate any text blocks to generate one or more vector graphics.

At 224, the plurality of graphical components can be combined into one or more vector graphics for the target graphical content based on the applicable templates and/or rules. In at least some examples, a vector graphic can be generated for each frame of a multi-frame video or live image.

At 226, each vector graphic can be optionally converted to a non-vector graphic form (e.g., png or jpg, or animated gif). This approach may be used in the case where the application program that initiated the request does not support vector graphics. In the case of animated images, the one or more applicable templates can be used to generate multiple image versions for each frame of the animation.

At 228, the graphical content is sent as a response to the client computing device responsive to the request received at 210.

As an example implementation of method 200, data processing engine 148 performs operations 210, 213, 214, 216, 218, 220, and 228; and graphics processing engine 150 performs operations 222, 224, and 226.

Aspects of computing system 100 FIG. 1 and method 200 of FIG. 2 are described in further detail below with reference to various example implementations.

In at least some examples, computing system 100 provides an architecture for dynamically generating images and/or videos (e.g., vector graphics) real-time or near-real-time for email, webpages, and other application contexts. The image, video, or other graphical content can be generated after a request is made based on contextual information extracted from data of the image request, or, indirectly with data from databases, APIs, or text files. This improved methodology and architecture can generate the images, videos, and other graphical content by directly stitching together data from different images, videos, or other sources.

For example, one image might be generated from a scalable vector graphic (SVG image) that was generated from a first set of data (e.g., includes a first name of a client user or a number of loyalty points associated with an account of the client user), another image might be an image fetched from a server store, a third image might be generated according to a data driven algorithm (e.g., applicable templates and/or rules implemented based on the request from the client) with the available data on a pixel by pixel basis (e.g., a gradient background image). The images, as graphical components, can be merged together according to the applicable rules and/or templates and returned to the requestor within, at the most, a few seconds from when the request was made, as an illustrative example.

As an example implementation of method 200: (1) a request comes in via HTTP(S) to the server system, (2) the server system fetches details about what data needs to be fetched and any logic to be processed in real-time based on the data, (3) any additional data needed is fetched by the server system from API calls, http requests, databases or text files, (4) logic defined by the templates and/or rules are processed by the server system in combination with the data to determine what the image and/or video should look like, (5) image assets like fonts, images, videos to be used in the generation of the new image are identified and/or obtained by the server system, and (6) the images (e.g., one or more) are generated from the data by the server system. The approach of step (6) could generate images either from processing an SVG template and adjusting it to contain elements from the data (e.g., first name, loyalty points, calendar information), or from fetching an image from a data store or HTTP, or from generating the image pixel by pixel based on the data (e.g., a gradient background, or a cloud generated from an algorithm). Next, at a step (7) the images can be programmatically merged together according to implemented instruction logic (e.g., templates and/or rules) for that image processed based on the data, and at a step (8) the image can be returned within a few seconds (at the most, often much faster) to the requestor.

The above approach differs from legacy approaches, which may, for example, use a web rendering engine to render a website based on the data and then screen-capture the result. By contrast, the approach disclosed herein can differ by utilizing image-based technology rather than web-based technology to generate the resulting image.

In at least some examples, computing system 100 provides an architecture for generating real-time or near real-time animated images and streamed video that contain data either passed through the request from the client for the animated image or streamed video or is enriched with data fetched after the initial request for the animated image or streamed video is made. The image/video can be processed and generated after the request is made, in the span of no more than a few seconds, often much faster, in contrast to existing data driven animations where the image is preprocessed and the request is routed to an existing animation. An example of the disclosed techniques would be implemented when a client user opens their email and the email application requests an image via HTTP protocol. The data indicated by contextual information contained in or otherwise indicated by the request can be used to change the content or motion of the animation that is generated, and immediately serve such modified content back to the requestor.

As an example implementation of method 200: (1) the request for an image or video is generated and received from the client in via HTTP(s), RMTP, or other suitable protocol. The request may contain specifics about the requestor (language preferences, IP address, supported image formats, and other http header data, as well as query parameters to be used directly or indirectly (calling APIs to fetch additional data) in the image (collectively contextual information), (2) the request is routed to a server system with enhanced capabilities to process images/videos, (3) the server data processing routine will fetch any additional data (database lookup, API calls, static text files, etc.) and graphical content (fonts, images, videos, etc.), needed for the image animation before generating each frame needed for the animated image, (4) there are at least two possibilities for generating the images, regardless of the end format (video or image format): (a) streaming video: images are generated in sequence and fed back to the requestor fast enough to keep up with the framerate or within acceptable real-time buffering parameters (buffers of between a few seconds to less than a minute are usually considered acceptable), and (b) image: after the image frames are generated, the finished image is stitched together and returned as a whole to the requestor within no more than a few seconds of when the request was made.

The above approach again differs from existing animations that precompile images before the request is received from the client in which data is routed to the existing pre-processed image. Examples of this approach are countdown timers, where the animated image is processed before the request is made for the image, and the request is instead routed to the preprocessed animated image. By contrast, the disclosed techniques enable graphical content to be customized or otherwise tailored to the particular client based on contextual data contained in or otherwise indicated by the request for the graphical content.

FIG. 3A schematically depicts example rules and templates 300 that can be applied or otherwise implemented by server system 112 of FIG. 1. In this example, an entry rule set 301 includes one or more rules 303-1, 303-2, 303-N, etc. that enable a particular template or set of templates to be selected for a given set of contextual information associated with a request from a client computing device. Rules of entry rule set 301 are non-limiting examples of rules 156 of FIG. 1.

As an example, rule 303-1 of entry rule set 301 includes one or more conditions (e.g., condition 305) and one or more template identifiers (e.g., 307). Upon contextual information satisfying the one or more conditions (e.g., 305) of rule 303-1, one or more templates of identified by template identifiers (e.g., 307) can be selected for use in generating graphical content. For example, template 302-1 can be identified and selected from among a plurality of templates 302-1, 302-2, 302-N, etc. based on template identifier 307. Rule 303-2 can be associated with template 302-2, and rule 303-N can be associated with identifier 302-N as other examples. These templates are non-limiting examples of templates 154 of FIG. 1.

Template 302-1 in this example defines features of a background layer of background layer identifier 304 and a foreground layer of foreground layer identifier 306 for a graphical content item to be generated. As an example, identifiers 304 and 306 that respectively identify graphical components for the background layer and the foreground layer of vector graphic 116 of FIG. 1. Accordingly, the background and foreground layers in this example refer to graphical components of a graphical content item. It will be understood that FIG. 3A is merely a schematic representation of an example graphical content item, and that features such as identifier 306 could have other types of dynamic blocks (e.g., an image block with a dynamic image that can be rotated, skewed, etc., or a vector graphic element such as lines, circles, etc.).

Identifiers such as 304 and 306 can be used by data processing engine 148 to retrieve, generate, and/or place the appropriate graphical components from local storage (e.g., storage machine 142) and/or remote data sources 162 when generating the target graphical content. Template 302-1 further includes a data item placeholder 308 that is associated with a data source identifier 312 from which a data item can be retrieved for inclusion in the data item placeholder 308. Again, identifier 312 can be used by data processing engine 148 to retrieve, generate, and/or place the appropriate graphical components from local storage (e.g., storage machine 142) and/or remote data sources 162. Additionally, in this example, features such as text font, size, color, etc. can be defined at 310 as part of template 302-1.

A template-specific rule set containing one or more rules can be associated with each template. As an example, template-specific rule set 313-1 containing rules 314-1, 314-2, 314-N, etc. can be associated with template 302-1, template-specific rule set 313-2 can be associated with template 302-2, template-specific rule set 313-N can be associated with template 302-N, etc. These template-specific rule sets are additional examples of rules 156 of FIG. 1. As previously described with reference to rule 303-1, each template-specific rule can include one or more conditions and one or more template identifiers with which the rule is associated. As an example, rules 314-1, 314-2, 314-N, etc. of template-specific rule set 313-1 are associated with template 302.

Referring to rule 314-1, as an example, this rule defines at 316 that if the data item retrieved for data item placeholder 308 is greater than a threshold value of zero, that the data item is to be included in data item placeholder 308, and if that data item is equal to zero, that the data item is to be omitted from data item placeholder 308 as defined at 318. It will be appreciated that other suitable templates and/or rules can be associated with each other, and selectively implemented based on contextual data contained in or indicated by a request received from a client.

FIG. 3B is a schematic diagram depicting a plurality of graphical content items 350 that can be generated or otherwise selected by data processing engine 148 of FIG. 1 for respective parameter groups 340 as example data inputs. In this example, each of parameter groups 340-1, 340-2, 340-3, 340-N of parameter groups 340 can refer to contextual information that defines features of graphical content items 350 to be generated or particular graphical content items to be selected by data processing engine 148. As an example, parameter groups 340 correspond to different personalization scenarios that serve as input to data processing engine 148. Such features of the graphical content can include how the content is requested by a client computing device, how the graphical content is to be transmitted over a network to the client computing device, the subject matter of media contained in the graphical content, and the format of the graphical content, as examples.

In FIG. 3B, a parameter set 320 includes a plurality of example parameters including one or more content request parameters 321, one or more media parameters 322, one or more client parameters 323, one or more context parameters 324, and one or more other parameters 325. Parameters of parameter set 320 can be included in the contextual information received from a client computing device and/or retrieved from another source based on data included in the contextual information. It will be understood that a parameter set can include different parameters and/or a greater or lesser quantity of parameters than example parameter set 320. For example, parameters 321-325 can represent general parameter categories that each contain a plurality of parameters (e.g., sub-parameters).

Content request parameters 321 can define how a client computing device requests content from the server system 112. Content request parameters 321 can include one or more code blocks of instructions executable by a client computing device to initiate the request for the content and/or a direct protocol request (e.g., HTTP request) by the client computing device for the content, as examples. In these examples, the client computing device execute the code blocks as part of sending the request to the server system. An example block code can include an HTML or other protocol block of code containing one or more media calls for the content as image URLs. Another example block code can include an HTML or other protocol block of code containing iframe or object HTML elements to be replaced with other HTML, image, or text as the content.

Media parameters 322 can include (1) a media type (e.g., dynamically generated, pre-generated, graphical (image, video, text), audio, etc.) of the content item, (2) the format of the content item (e.g., file type, resolution, etc.), (3) a channel via which the content item is to be presented at the client (e.g., email application, SMS messaging, instant messaging, web page in browser, mobile application, desktop application, web application, etc.). As an example, dynamically generated and/or pre-generated media content may render differently based on the channel that the content is served on.

Client parameters 323 can include (1) an identity of the client and/or client user, (2) a client device type, (3) an application type or version used to request and present the content at the client computing device, and (4) a protocol header of the transport protocol (e.g., HTTP) used by the client to request and receive the content. For example, transport protocols can utilize different headers for language, accepted formats, user-agent, etc., may utilize a different IP address for the transport request, and may have a different path or query parameters. As an example, an HTTP request can use a query parameter such as “?first name=Carl” (e.g., as a first name parameter) or a path “/user/12345” where 12345 may be a unique identifier. Additional examples of client parameters 323 can identify accepted media formats (.jpg, .gif, .svg, .png, .webp, etc.) and/or client feature support for inline CSS, .gif support, and other client-specific features.

Context parameters 324 can include parameters such as (1) a time of the request, (2) a date of the request, (3) a location of the client computing device, and/or (4) intermediate proxies used to facilitate communication. Location can refer to a network location (e.g., IP address or IP address range) and/or a geographic location (e.g., city, state, country, longitude/latitude, etc.) for the client computing device.

A domain of values can be defined for each parameter of parameter set 320. For example, parameter 321 has a domain 331 containing values 331-1 through 331-N, parameter 322 has a domain 332 containing values 332-1 through 332-N, parameter 323 has a domain 333 containing values 333-1 through 333-N, parameter 324 has a domain 334 containing values 334-1 through 334-N, and parameter 325 has a domain 335 containing values 335-1 through 335-N.

Each parameter group of the plurality of parameter groups 340 includes a different combination of values among the plurality of parameters of parameter set 320. For example, parameter group 340-1 includes values 331-1, 332-1, 333-1, 334-1, and 335-1 of parameter 321, parameter 322, parameter 323, parameter 324, and parameter 325, respectively. Parameter group 340-2 includes values 331-1, 332-2, 333-2, 334-2, and 335-2 of parameter 321, parameter 322, parameter 323, parameter 324, and parameter 325, respectively. Parameter group 340-3 includes values 331-1, 332-3, 333-3, 334-3, and 335-3 of parameter 321, parameter 322, parameter 323, parameter 324, and parameter 325, respectively. Parameter group 340-N includes values 331-N, 332-N, 333-N, 334-N, and 335-N of parameter 321, parameter 322, parameter 323, parameter 324, and parameter 325, respectively.

In at least some implementations, the quantity of parameter groups for a parameter set can be represented by the product of the quantity of possible values of each parameter. For example, a parameter set of five parameters each having five possible values can form 125 different combinations of values corresponding to 3,125 parameter groups. It will be understood that parameters of a parameter set can have different quantities of values relative to other parameters of the parameter set. For example, a parameter set of three parameters A, B, and C can have several values for parameter A, dozens of values for parameter B, and hundreds of values for parameter C.

The initial domain of values for a given parameter can include one or more discrete values and/or one or more value ranges. The term “value” as used herein can refer to numerical values, text values, alphanumeric values, computer-executable instructions, and/or other forms of data. Such values can refer to other data or content, and can include network addresses and/or resource identifiers at or by which other data or content components can be accessed by data processing engine 148.

Each of parameter groups 340 corresponds to a different graphical content item of graphical content items 350 that is generated or otherwise selected by data processing engine 148 by application of a rule-template framework, such as described with reference to FIG. 3A. As an example, graphical content item 350-1 is obtained responsive to parameter group 340-1 as an input, graphical content item 350-2 is obtained responsive to parameter group 340-2 as an input, graphical content item 350-3 is obtained responsive to parameter group 340-3 as an input, graphical content item 350-4 is obtained responsive to parameter group 340-4 as an input, and graphical content item 350-N is obtained responsive to parameter group 340-N as an input. Thus, a population of requesting client devices can receive different graphical content items based on the contextual information contained in and/or indicated by the request.

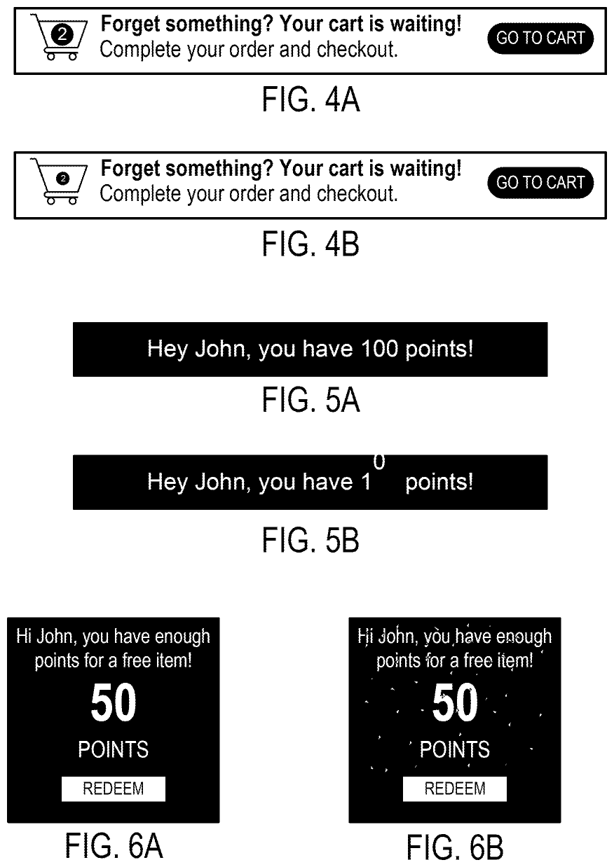

FIGS. 4A and 4B depict an example of graphical content that can be provided to a client using the techniques disclosed herein. In this example, a shopping cart abandonment animation is provided for a data source that includes an e-commerce API to retrieve the number of items in a customer's cart (e.g., 2 items). In FIGS. 4A and 4B, a black circle containing the number of items in the customer's cart expands and contracts as part of an animation. The disclosed techniques enable the animation to include a variety of client-specific information, such as the customer's name, the exact items in the cart, etc. The animation can incorporate or be based on contextual data such as client location, time of day, geographic location, etc. For example, the animation can incorporate data retrieved from any suitable API data source by the server system.

FIGS. 5A and 5B depict another example of graphical content that can be provided to a client using the techniques disclosed herein. In this example, an animated loyalty points banner is provided that includes client-specific information, such as the name of the client user (e.g., John) and a quantity of loyalty points associated with an account of the client user (e.g., 100 points). As an example, the numbers 1, 0, and 0 representing the 100 loyalty points can move into place from outside of the animation frame. Data source being used in this example can include a loyalty API to retrieve customer loyalty points and customer name. The animation can include data from multiple data sources, including the client computing device, local data sources of the server system, and remote data sources other than the client computing device.

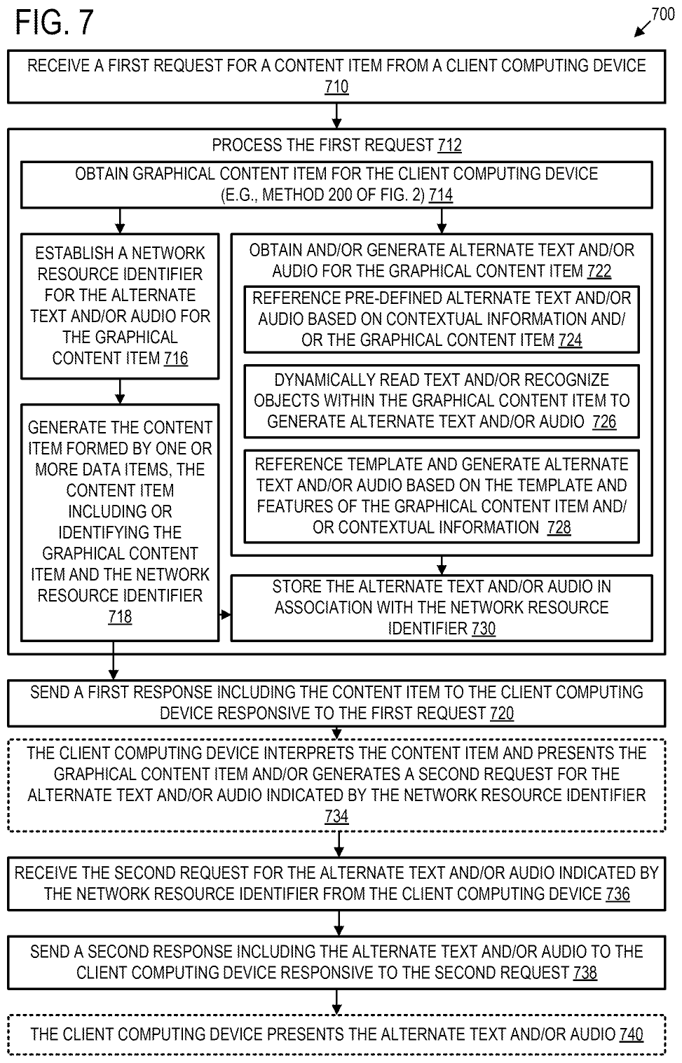

FIGS. 6A and 6B depict another example of graphical content that can be provided to a client using the techniques disclosed herein. In this example, another animation of loyalty points is provided that includes the client user's name (e.g., John), the number of points associated with the client user, and falling confetti as a background layer of the animation. The background layer in this example can originate from a different data source than the points and/or the client username. For example, the background layer can be stored locally at the server system and/or form part of the implemented template, whereas the number of points and the name of the client user can be retrieved from a remote data source.

FIG. 7 depicts a flow diagram 700 of another example method that can be performed by aspects of computing system 100 of FIG. 1.

At 710, the method includes receiving a first request for a content item from a client computing device. The content item requested at operation 710 can include or identify the graphical content item provided by method 200 of FIG. 2, as an example. The client computing device can refer to client computing device 110 of FIG. 1.

At 712, the method includes processing the first request. As part of operation 712, the method at 714 includes obtaining a graphical content item for the client computing device. Operation 714 can include previously described operation 212 of FIG. 2, as an example.

At 716, the method includes establishing a network resource identifier (e.g., a URL) for alternate text and/or audio representing the alternate text for the graphical content item obtained at operation 714.

At 718, the method includes generating the content item for the first request. The content item can be formed by one or more data items, including or identifying the graphical content item and the network resource identifier. For example, the content item can include the graphical content item or a first network resource identifier (e.g., URL) for the graphical content item, and can further include a second network resource identifier (e.g., URL) for the alternate text and/or the audio representation of the alternate text.

At 720, the method includes sending a first response including the content item to the client computing device responsive to the first request. Previously described operations 710-720 can be performed by one or more servers of a server system, such as server system 112 of FIG. 1.

Before, after, or during performance of operations 716, 718, and 720, operation 722 can be performed by the server system. At 722, the method includes obtaining and/or generating the alternate text and/or audio representing the alternate text for the graphical content item.

As a first example, at 724, the alternate text and/or the audio representing the alternate text can be pre-defined, enabling these items to be referenced from data storage and/or selected from among a plurality of selectable items based on contextual information and/or the graphical content item obtained for the request at 714. The audio representing the alternate text can be generated on the fly based on the pre-defined alternate texts, in at least some examples, by application of text-to-speech and computer synthesized speech technologies implemented by the server system.

As a second example, at 726, text within the graphical content item can be dynamically read and/or objects within the graphical content item can be recognized by application of machine vision to generate the alternate text and/or audio representing the alternate text. For example, referring again to FIGS. 5A and 5B, the text “Hey John, you have 100 points!” can be read from the graphical content item and converted to an audio representation of that text by application of text-to-speech and computer synthesized speech technologies implemented by the server system.

As a third example, at 728, one or more applicable templates and/or rules for the graphical content item can be referenced, and the alternate text and/or audio representation of the alternate text can be generated based on the template/rules and features of the graphical content item and/or the contextual information. As an example, the template that was used to generate the graphical content item can be the same template or associated with another template that is used to generate the alternate text and/or audio representation of the alternate text. Template 310 is an example of a template that can be used to generate the alternate text and/or audio representation. As another example, a template for alternate text can define a text script such as: “A [insert type of graphical content item (e.g., image, video, etc.)] is displayed titled [insert title of graphical content item] and that is [insert other defined properties of the graphical content item (e.g., duration of a video)]. The graphical content item contains [insert “text” if text is present] that says [insert text identified or defined as being within graphical content item having an order that is based on a time-based sequence of the text within a set of video frames and/or based on a language-defined reading direction within each frame] and further contains [insert object types or classes identified or defined as being within the graphical content item]”. Again, the audio representation can be generated by application of text-to-speech and computer synthesized speech technologies implemented by the server system using the alternate text.

At 730, the alternate text and/or the audio representation of the alternate text is stored in association with the network resource identifier, thereby enabling these items to be retrieved responsive to requests that use or include the network resource identifier.

At 734, the client computing device interprets the content item and presents the graphical content item thereof via a display device. Additionally or alternatively, the client computing device generates a second request for the alternate text and/or the audio representing the alternate text as indicated by the network resource identifier of the content item.

At 736, the method includes receiving the second request for the alternate text and/or the audio representing the alternate text as indicated by the network resource identifier from the client computing device.

At 738, the method includes sending a second response including the alternate text and/or the audio representing the alternate text to the client computing device responsive to the second request. Operations 736 and 738 can be performed by the same or a different server of the server system from a server that performed operations 710-730. Furthermore, in at least some examples, the alternate content can be generated responsive to the second request, as previously described with reference to operation 722.

At 740, the client computing device presents the alternate text and/or audio representing the alternate text. For example, the alternate text can be presented via a display device and/or converted to an audible readout of the alternate text by an application of the client computing device by local application of text-to-speech and computer synthesized speech technologies implemented using the alternate text. The audio representing the alternate text that is sent to the client computing device by the server system can also be presented, for example, by outputting the audio via an audio device (e.g., an audio speaker or other suitable audio interface).

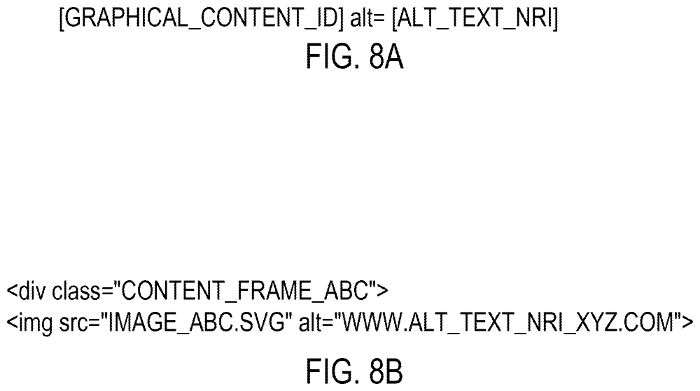

FIG. 8A depicts an example syntax for computer executable instructions contained within the content item described above with respect to method 700 of FIG. 7. In this example, the syntax includes: [GRAPHICAL_CONTENT_ID] alt=[ALT_TEXT_NRI], whereby the [GRAPHICAL_CONTENT_ID] is the identifier (e.g., source identifier or network resource identifier) of the graphical content item, [ALT_TEXT_NRI] is the network resource identifier of the alternate text and/or audio representation of the alternate text for the graphical content item, and the “alt=” property defines the following network resource identifier as referring to alternate text or its audio representation. In this example, the “alt=” property and syntax corresponds to the alternate text expression used in HTML. As an example, within the context of HTML, the HTMLImageElement property “alt” can be used to enable alternate text to be provided when a graphical content item defined by an “<img>” element is not loaded or in addition to loading and displaying the graphical content. It will be understood that other suitable properties and syntax can be used.

FIG. 8B depicts an example of computer executable instructions contained within the content item described above with respect to method 700 of FIG. 7, using the syntax of FIG. 8A. In this example, <div class=“CONTENT_FRAME_ABC”> refers to the content frame (e.g., 130) within the GUI, <img src=“IMAGE_ABC.SVG” refers to the identifier of the graphical content item, and alt=“WWW.ALT_TEXT_NRI_XYZ.COM”> refers to the alternate text property and network resource identifier where the alternate text and/or its audio representation can be retrieved. The example computer executable instructions of FIGS. 8A and 8B can be interpreted by the application program (e.g., 126) executed at the client computing device, which could include a web browser, an email application, or other suitable application program.

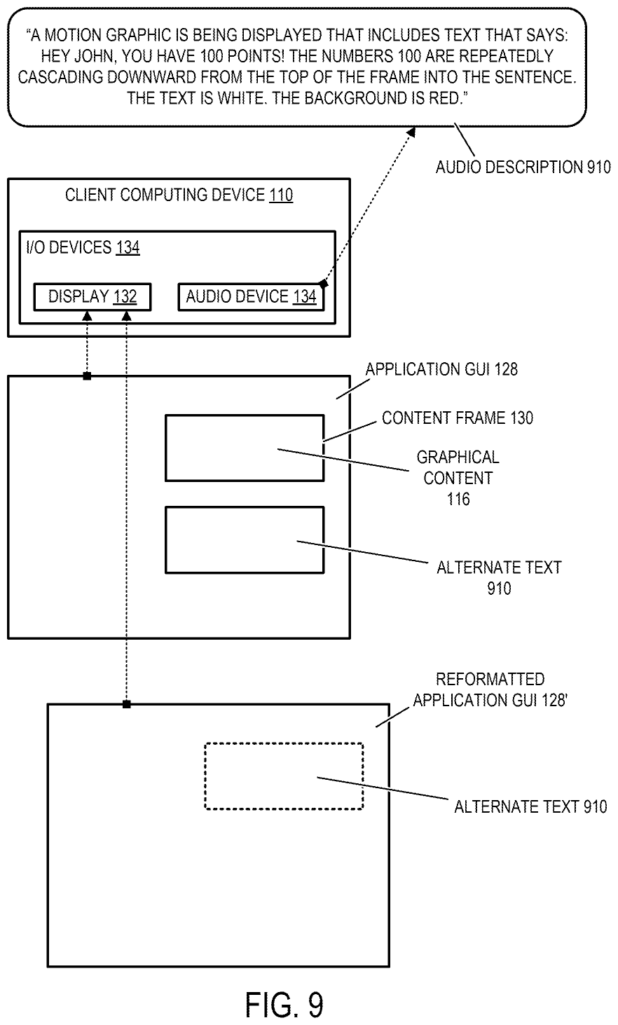

FIG. 9 depicts an example of client computing device 110 of FIG. 1 audibly outputting an audio description of graphical content item 116. In this example, the audio description 910 is output via an audio device 912 (e.g., audio speaker or audio connector) of input/output devices 134 that describes features of the graphical content item of FIGS. 5A and 5B. Additionally, in this example, alternate text 910 for graphical content item 116 is displayed within the application GUI 128. Alternatively, a reformatted GUI 128′ can be displayed that includes alternate text 910 and omits graphical content 116. In at least some examples, the application program of the client computing device can enable a user to select or preset whether presentation of the graphical content is to be omitted.

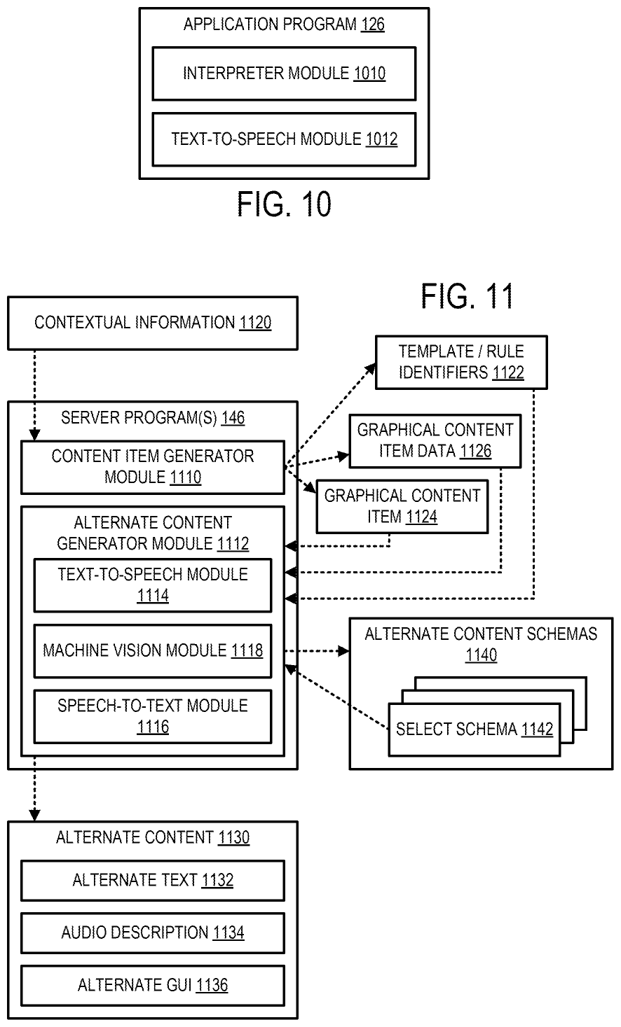

FIG. 10 depicts additional aspects of application program 126 of FIG. 1. In this example, application program 126 includes an interpreter module that interprets the computer executable instructions of the content item, including the network resource identifier for the alternate text or its audio representation. Application program 126 additionally includes a text-to-speech module 1012 that can convert text into computer synthesized speech locally at the client computing device. Text-to-speech module 1012 can be used to audibly output the alternate text.

FIG. 11 depicts additional aspects of the one or more server programs 146 of FIG. 1. In this example, server programs 146 include a content item generator module 1110 that is used to perform method 200 and operation 714 of FIG. 7. As an example, module 1110 can form part of data processing engine 148 and/or graphical processing engine 150 of FIG. 1.

Server programs 146 additionally include an alternate content generator module 1112 that generate alternate text, an alternate GUI, and/or an audio description for a graphical content item as described with reference to operations 716-730 of FIG. 7. As an example, module 1112 can form part of data processing engine 148 of FIG. 1.

Server programs 146 can further include a text-to-speech module 1114 for converting text to an audio representation of that text, a speech-to-text module 1116 that can convert spoken language within an audio component of the graphical content item into the alternate text, and a machine vision module 1118 that can identify text and other objects contained within the graphical content item. Modules 1114, 1116, and 1118 can form part of alternate content generator module 1112 in at least some implementations.

Module 1112 can selectively utilize modules 1114, 1116, and 1118 to generate the alternate text and/or the audio description of the alternate text for the graphical content item. As an example, machine vision module 1118 can apply machine vision technologies to each frame of a multi-frame video or other motion graphic to identify a time-based sequence of text, objects, events, etc. that are present within that graphical content item. An output of the machine vision applied to the graphical content can include the alternate text or text components of the alternate text. The alternate text that describes the time-based sequence of text, objects, events, etc. can be generated to provide a script that is read in an order that is defined by or that generally conforms to the time-based sequence of text, objects, events, etc. identified by machine vision.

In the example of FIG. 11, contextual information 1120 extracted from a request received from a client computing device is used by content item generator module 1110 to select or otherwise identify one or more applicable templates and/or rules indicated by template/rule identifiers 1122. Module 1110 generates or otherwise selects a graphical content item 1124 for delivery to the client computing device responsive to the request. Additionally, module 1110 can output data 1126 (e.g., text, graphical components, etc.) that is used to generate graphical content item 1124.

Data 1126, identifiers 1122, and graphical content item 1124 can be provided to module 1112 where it can be used to generate alternate content 1130. As previously described, alternate content can include alternate text 1132 for graphical content item 1124, an audio description of graphical content item 1124, and/or an alternate GUI 1136 for the client computing device. As an example, machine vision module 1118 can apply machine vision to graphical content item 1124 to generate alternate text 1132. Alternatively or additionally, alternate text 1132 and/or data 1126 (e.g., text and/or graphical components) used to generate graphical content item 1124 can be used by text-to-speech module 1114 to generate audio description 1134. Alternatively or additionally, speech-to-text module 1116 can be used to generate text representations of audio associated with graphical content item (e.g., audio accompanying video or other motion graphic) as part of alternate text 1132.

FIG. 11 further depicts alternate content schemas 1140, which can be used by alternate content generator module to generate alternate content 1130 based on data 1126, identifiers 1122, and graphical content item 1124 as inputs. In at least some implementations, schemas 1140 can form part of data 145 of FIG. 1. According to an example, a select schema 1142 can be selected by module 1112 from a plurality of available schemas based on one or more of these inputs 1122, 1124, and 1126. A respective schema can be associated with each template identifier and/or rule identifier. Alternatively, a respective schema can be associated with each graphical content item that is available to be served to client computing devices. Each schema can define an order (e.g., a script) and/or content (e.g., data items) of alternate text 1132, as an example.

Referring again to the graphical content item of FIGS. 5A and 5B as an example, schema 1142 can define the following alternate text configuration: “A [insert graphic type] is being displayed that includes text that says: Hey [insert client username], you have [insert point total] points! The numbers [insert numbers comprising point total] are [insert action] from [insert direction] into the sentence. The text is [insert text color]. The background is [insert background color].” The resulting alternate text and/or audio description for this schema can refer to the example of FIG. 9 for the graphical content item of FIGS. 5A and 5B, which states: “A MOTION GRAPHIC IS BEING DISPLAYED THAT INCLUDES TEXT THAT SAYS: HEY JOHN, YOU HAVE 100 POINTS! THE NUMBERS 100 ARE REPEATEDLY CASCADING DOWNWARD FROM THE TOP OF THE FRAME INTO THE SENTENCE. THE TEXT IS WHITE. THE BACKGROUND IS RED.”

In some embodiments, the methods and processes described herein may be tied to a computing system of one or more computing devices. In particular, such methods and processes may be implemented as a computer-application program or service, an application-programming interface (API), a library, and/or other computer-program product.

Computing system 100 is shown in simplified form. Computing system 100 may take the form of one or more personal computers, server computers, tablet computers, home-entertainment computers, network computing devices, gaming devices, mobile computing devices, mobile communication devices (e.g., smart phone), and/or other computing devices.

Computing system 100 includes logic machines and a storage machines. Logic machines include one or more physical devices configured to execute instructions. For example, the logic machines may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machines may include one or more processors configured to execute software instructions. Additionally or alternatively, the logic machines may include one or more hardware or firmware logic machines configured to execute hardware or firmware instructions. Processors of the logic machines may be single-core or multi-core, and the instructions executed thereon may be configured for sequential, parallel, and/or distributed processing. Individual components of the logic machines optionally may be distributed among two or more separate devices, which may be remotely located and/or configured for coordinated processing. Aspects of the logic machines may be virtualized and executed by remotely accessible, networked computing devices configured in a cloud-computing configuration.

Storage machines include one or more physical devices configured to hold instructions executable by the logic machines to implement the methods and processes described herein. When such methods and processes are implemented, the state of storage machines may be transformed—e.g., to hold different data. Storage machines may include removable and/or built-in devices. Storage machines may include optical memory, semiconductor memory (e.g., RAM, EPROM, EEPROM, etc.), and/or magnetic memory (e.g., hard-disk drive, floppy-disk drive, tape drive, MRAM, etc.), among others. Storage machines may include volatile, nonvolatile, dynamic, static, read/write, read-only, random-access, sequential-access, location-addressable, file-addressable, and/or content-addressable devices. It will be appreciated that storage machines include one or more physical devices. However, aspects of the instructions described herein alternatively may be propagated by a communication medium (e.g., an electromagnetic signal, an optical signal, etc.) that is not held by a physical device for a finite duration.

Aspects of logic machines and storage machines may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 100 implemented to perform a particular function. In some cases, a module, program, or engine may be instantiated via a logic machine executing instructions held by a storage machine. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that the term “service” may be used to describe a program executable across multiple user sessions. A service may be available to one or more system components, programs, and/or other services. In some implementations, a service may run on one or more server-computing devices.

When included, a display may be used to present a visual representation of data held by a storage machine. This visual representation may take the form of a GUI. As the herein described methods and processes change the data held by the storage machine, and thus transform the state of the storage machine, the state of the display may likewise be transformed to visually represent changes in the underlying data. A display may include one or more display devices utilizing virtually any type of technology. Such display devices may be combined with a logic machine and/or a storage machine in a shared enclosure, or such display devices may be peripheral display devices.

When included, a communication subsystem of the input/output interfaces may be configured to communicatively couple computing devices of computing system 100 with one or more other computing devices. The communication subsystem may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow devices of computing system 100 to send and/or receive messages to and/or from other devices via a network such as the Internet.

According to an example of the present disclosure a method performed by a computing system comprises: receiving a first request for a content item from a client computing device via a communications network; extracting contextual information from the first request; obtaining a graphical content item for the client computing device based, at least in part, on the contextual information by generating the graphical content item or selecting the graphical content item from a plurality of available graphical content items; generating alternate text and/or an audio description for the graphical content item; establishing a network resource identifier from which the alternate text and/or audio description is retrievable by the client computing device; responsive to the first request, sending a first response including the content item to the client computing device via the communications network, the content item including or identifying the graphical content item and the network resource identifier; receiving from the client computing device via the communications network a second request for the alternate text and/or audio description indicated by the network resource identifier; and responsive to the second request, sending a second response including the alternate text and/or audio description to the client computing device via the communications network. In this example or other examples disclosed herein, the graphical content item can be generated by the computing system responsive to the first request. In this example or other examples disclosed herein, generating the graphical content item can include: identifying one or more applicable templates and/or rules for the graphical content item based on the contextual information; generating a plurality of graphical components for the graphical content item based on the one or more applicable templates and/or rules; and combining the plurality of graphical components based on the one or more applicable templates and/or rules to obtain the graphical content item. In this example or other examples disclosed herein, the plurality of graphical components can include one or more vector graphics; and the method can further include converting the one or more vector graphics to non-vector graphic form to obtain the graphical content item. In this example or other examples disclosed herein, extracting the contextual information from the first request can include obtaining at least some of the contextual information from one or more data sources remote from the client computing device based on one or more identifiers contained in the first request. In this example or other examples disclosed herein, at least some of the contextual information can be contained in the first request. In this example or other examples disclosed herein, at least some of the contextual information can be obtained from one or more data sources remote from the client computing device. In this example or other examples disclosed herein, the audio description can be generated for the graphical content item; and generating the audio description can further include applying text-to-speech to a text component of the graphical content item; and the audio description can be sent to the client computing device. In this example or other examples disclosed herein, generating the alternate text and/or the audio description further can include applying machine vision to the graphical content item. In this example or other examples disclosed herein, generating the alternate text and/or the audio description can include applying data used to generate the graphical content item to a schema. In this example or other examples disclosed herein, generating the alternate text and/or the audio description can be performed responsive to the first request. In this example or other examples disclosed herein, generating the alternate text and/or the audio description can be performed responsive to the second request. In this example or other examples disclosed herein, the graphical content item is one of a plurality of graphical content items selectable by the computing system, and the graphical content item can selected from the plurality of graphical content items responsive to the first request; and generating the alternate text and/or the audio description can be performed prior to receiving the first request; and the alternate text and/or the audio description can be selected for the graphical content item responsive to the first request or the second request.

According to another example of the present disclosure, a computing system of one or more computing devices, comprises: a logic machine; and a data storage machine having instructions stored thereon executable by the logic machine to perform the methods or operations disclosed herein.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed. The claimed subject matter of the present disclosure includes all novel and non-obvious combinations and sub-combinations of the various processes, systems and configurations, and other features, functions, acts, and/or properties disclosed herein, as well as any and all equivalents thereof.

1. A method performed by a computing system, the method comprising:
receiving a first request for a content item from a client computing device via a communications network;
extracting contextual information from the first request;
obtaining a graphical content item for the client computing device based, at least in part, on the contextual information by generating the graphical content item or selecting the graphical content item from a plurality of available graphical content items;
generating alternate text and/or an audio description for the graphical content item;
establishing a network resource identifier from which the alternate text and/or audio description is retrievable by the client computing device;
responsive to the first request, sending a first response including the content item to the client computing device via the communications network, the content item including or identifying the graphical content item and the network resource identifier;
receiving from the client computing device via the communications network a second request for the alternate text and/or audio description indicated by the network resource identifier; and
responsive to the second request, sending a second response including the alternate text and/or audio description to the client computing device via the communications network.

2. The method of claim 1, wherein the graphical content item is generated by the computing system responsive to the first request.

3. The method of claim 2, wherein generating the graphical content item includes:
identifying one or more applicable templates and/or rules for the graphical content item based on the contextual information;
generating a plurality of graphical components for the graphical content item based on the one or more applicable templates and/or rules; and
combining the plurality of graphical components based on the one or more applicable templates and/or rules to obtain the graphical content item.

4. The method of claim 3, wherein the plurality of graphical components include one or more vector graphics; and
wherein the method further includes converting the one or more vector graphics to non-vector graphic form to obtain the graphical content item.

5. The method of claim 2, wherein extracting the contextual information from the first request includes obtaining at least some of the contextual information from one or more data sources remote from the client computing device based on one or more identifiers contained in the first request.

6. The method of claim 2, wherein at least some of the contextual information is contained in the first request.

7. The method of claim 6, wherein at least some of the contextual information is obtained from one or more data sources remote from the client computing device.

8. The method of claim 1, wherein the audio description is generated for the graphical content item;
wherein generating the audio description further includes applying text-to-speech to a text component of the graphical content item; and
wherein the audio description is sent to the client computing device.

9. The method of claim 1, generating the alternate text and/or the audio description further includes applying machine vision to the graphical content item.

10. The method of claim 2, wherein generating the alternate text and/or the audio description includes applying data used to generate the graphical content item to a schema.

11. The method of claim 1, wherein generating the alternate text and/or the audio description is performed responsive to the first request.

12. The method of claim 1, wherein generating the alternate text and/or the audio description is performed responsive to the second request.

13. The method of claim 1, wherein the graphical content item is one of a plurality of graphical content items selectable by the computing system, and the graphical content item is selected from the plurality of graphical content items responsive to the first request;
wherein generating the alternate text and/or the audio description is performed prior to receiving the first request; and
wherein the alternate text and/or the audio description is selected for the graphical content item responsive to the first request or the second request.

14. A computing system of one or more computing devices, comprising:
a logic machine; and
a data storage machine having instructions stored thereon executable by the logic machine to:
receive a first request for a content item from a client computing device via a communications network;
extract contextual information from the first request;
obtain a graphical content item for the client computing device based, at least in part, on the contextual information by generating the graphical content item or selecting the graphical content item from a plurality of available graphical content items;
generate alternate text and/or an audio description for the graphical content item;
establish a network resource identifier from which the alternate text and/or audio description is retrievable by the client computing device;
responsive to the first request, send a first response including the content item to the client computing device via the communications network, the content item including or identifying the graphical content item and the network resource identifier;
receive from the client computing device via the communications network a second request for the alternate text and/or audio description indicated by the network resource identifier; and
responsive to the second request, send a second response including the alternate text and/or audio description to the client computing device via the communications network.

15. The computing system of claim 14, wherein the graphical content item is generated responsive to the first request; and
wherein the instructions are further executable by the logic machine to generate the graphical content item by:
identifying one or more applicable templates and/or rules for the graphical content item based on the contextual information;
generating a plurality of graphical components for the graphical content item based on the one or more applicable templates and/or rules;
combining the plurality of graphical components based on the one or more applicable templates and/or rules to obtain the graphical content item.

16. The computing system of claim 14, wherein the plurality of graphical components include one or more vector graphics; and
wherein the instructions are further executable by the logic machine to convert the one or more vector graphics to non-vector graphic form to obtain the graphical content item.

17. The computing system of claim 14, wherein the audio description is generated for the graphical content item;
wherein the audio description is generated by applying text-to-speech to a text component of the graphical content item; and
wherein the audio description is sent to the client computing device.

18. The computing system of claim 14, wherein the alternate text and/or the audio description is generated by applying machine vision to the graphical content item.

19. The computing system of claim 14, wherein the alternate text and/or the audio description is generated by applying data used to generate the graphical content item to a schema.

20. An article, comprising:
a data storage machine including instructions stored thereon executable by one or more computing devices to:
receive a first request for a content item from a client computing device via a communications network;
extract contextual information from the first request;
responsive to the first request, generate a graphical content item for the client computing device based, at least in part, on the contextual information;
generate alternate text and/or an audio description for the graphical content item by applying text-to-speech and/or machine vision to the graphical content item or to data used to generate the graphical content item;
establish a network resource identifier from which the alternate text and/or audio description is retrievable by the client computing device;
responsive to the first request, send a first response including the content item to the client computing device via the communications network, the content item including or identifying the graphical content item and the network resource identifier;
receive from the client computing device via the communications network a second request for the alternate text and/or audio description indicated by the network resource identifier; and
responsive to the second request, send a second response including the alternate text and/or audio description to the client computing device via the communications network.
